(19) United States
(12) Patent Application Publication
(10) Pub. No.: US 2004/0164998 A1
(43) Pub. Date: Aug. 26, 2004

(54) Apparatus and method for displaying browser graphic according to aspect ratio

(75) Inventors: Kil-soo Jung, Gyeonggi-do (KR); Hyun-kwon Chung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/785,001

(22) Filed: Feb. 25, 2004

(30) Foreign Application Priority Data
Feb. 26, 2003 (KR) 2003-11956

(51) Int. Cl. G09G 5/00

(52) U.S. Cl. 345/619

(57) ABSTRACT

Browser graphics can be displayed according to an aspect ratio by providing a browser graphic storage unit storing browser graphics of different aspect ratios according to their aspect ratio, and an initialization file storage unit storing an initialization file including predetermined aspect ratio information. An aspect ratio information extractor extracts the aspect ratio information from the stored initialization file and a browser graphic selector selects a browser graphic from the stored browser graphics of different aspect ratios that corresponds to the extracted aspect ratio. A browser graphic display unit displays the selected browser graphic. Browser graphics having various aspect ratios are used to prevent the browser graphics from being distorted when displayed on various types of display devices, and to display the browser graphics corresponding to a default aspect ratio set by a contents producer, a request of a user, or characteristics of a display device.

### CROSS-REFERENCE TO RELATED APPLICATIONS

This application claims the priority benefit of Korean Patent Application No. 2003-11956, filed on Feb. 26, 2003, in the Korean Intellectual Property Office, the disclosure of which is incorporated herein in its entirety by reference.

### BACKGROUND OF THE INVENTION

1. Field of the Invention

The present invention relates to an apparatus and method for displaying a graphic included in a browser.

2. Description of the Related Art

Conventional Internet browsers (for example, Internet EXPLORER and NETSCAPE) have browser graphics, of which a displaying type cannot be decided by a markup document producer. A browser graphic is a graphic included in the browser, such as a submit button, a reset button, a checkbox button, or a radio button, which is realized (e.g., called) by a form tag, which specifies a fill-out form within a hypertext markup language (HTML) document. Shape and size of the browser graphic are set different for each browser, however, the browser graphic is formed based on an aspect ratio of 1:1. Therefore, browser graphics are formed appropriately on a monitor having a 1:1 aspect ratio, but if the browser graphics are displayed on a device having a different aspect ratio (for example, a television), the shape of the browser graphics may be distorted.

Conventional interactive digital video disks (DVD) are able to display audio visual (AV) data in an interactive mode. The interactive DVD includes the AV data according to conventional image standards, and also includes information related to markup documents required to support interactive functions (i.e., includes interactive contents markup documents as interactive contents). The interactive DVD displays images when commanded to do so by the markup document. In order to display the images, a browser for the interactive DVD is required. The browser for the interactive DVD supports the markup tags used in the Internet browser, and thus, the DVD browser also has the graphic elements used in the Internet browser. However, since the browser for the interactive DVD can be used in reproducing devices that tend to be connected to display devices with various aspect ratios, such as the television monitor, if the browser graphics are formed only in the 1:1 aspect ratio, the image may be distorted when displayed on the display device.

### SUMMARY OF THE INVENTION

The present invention provides an apparatus and method for displaying a browser graphic on reproducing devices having various display aspect ratios without distorting an image.

Additional aspects and/or advantages of the invention will be set forth in part in the description which follows and, in part, will be obvious from the description, or may be learned by practice of the invention.

The present invention may be achieved by an apparatus displaying browser graphics by an aspect ratio comprising a browser graphic storage unit storing browser graphics by aspect ratios, the browser graphics included in browsers displayed in different aspect ratios; an initialization file storage unit storing an initialization file including predetermined aspect ratio information; an aspect ratio information extractor extracting the aspect ratio information by analyzing the initialization file stored in the initialization file storage unit; a browser graphic selector selecting the browser graphic corresponding to the aspect ratio extracted by the aspect ratio information extractor from among the browser graphics of different aspect ratios stored in the browser graphic storage unit; and a browser graphic displaying unit displaying the browser graphic selected by the browser graphic selector.

The present invention may also be achieve by a method of displaying a browser graphic by an aspect ratio comprising storing browser graphics having different aspect ratios and included in browsers displayed in different aspect ratios; storing an initialization file including predetermined aspect information; extracting the aspect ratio information by analyzing the initialization file; selecting a browser graphic corresponding to the extracted aspect ratio from among the stored browser graphics; and displaying the selected browser graphic.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a functional block diagram of an apparatus that displays browser graphics by an aspect ratio according to an exemplary embodiment of the present invention;

FIG. 2 is a markup document source code as an example of an aspect ratio information initialization file implemented as an initialization file markup document, according to an embodiment of the present invention;

FIG. 3 illustrates an input button, which is an example of browser graphics produced according to an aspect ratio, according to an embodiment of the present invention;

FIG. 4 illustrates a checkbox, which is an example of the browser graphics produced according to an aspect ratio, according to an embodiment of the present invention;

FIG. 5 illustrates a radio button, which is an example of the browser graphics produced according to an aspect ratio, according to an embodiment of the present invention;

FIG. 6 illustrates a drop box, which is an example of the browser graphics produced according to an aspect ratio, according to an embodiment of the present invention;

FIG. 7 illustrates a list box, which is an example of the browser graphics produced according to an aspect ratio, according to an embodiment of the present invention;

FIG. 8 illustrates a text window, which is an example of the browser graphics produced according to an aspect ratio, according to an embodiment of the present invention;

FIG. 9 illustrates a text area window, which is an example of the browser graphics produced according to an aspect ratio, according to an embodiment of the present invention; and

FIG. 10 is a flow chart of displaying browser graphics, according to an exemplary embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

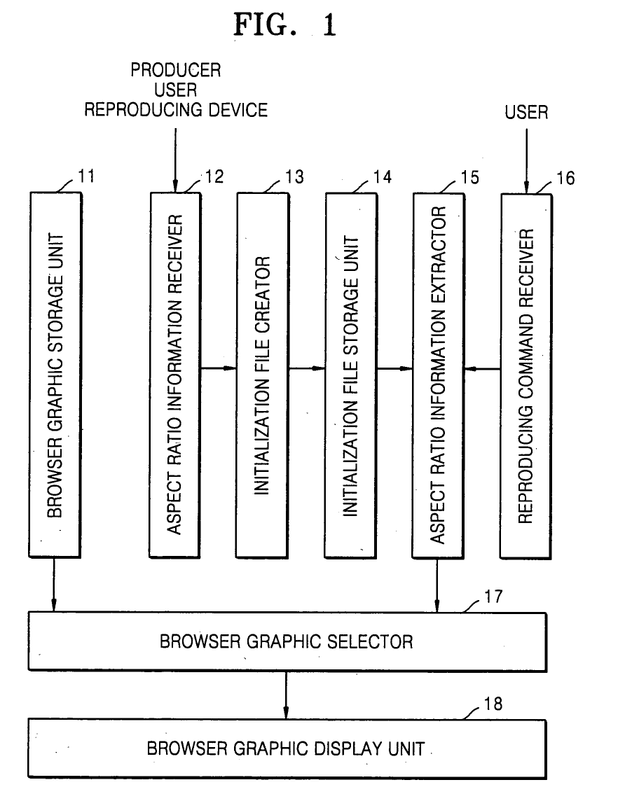

FIG. 1 is a functional block diagram of an apparatus that displays browser graphics by an aspect ratio, according to an exemplary embodiment of the present invention. The apparatus displaying browser graphics according to display aspect ratios (hereinafter referred to as aspect ratios), for example, comprises a browser graphic storage unit 11, an aspect ratio information receiver 12, an initialization file creator 13, an initialization file storage unit 14, an aspect ratio information extractor 15, a reproducing command receiver 16, a browser graphic selector 17, and a browser graphic display unit 18. A browser graphic is a graphic included in a browser and for which a displaying type cannot be determined by a markup document producer.

The browser graphic storage unit 11 stores browser graphics by aspect ratio, and in which the browser graphics are included in browsers displayed in different aspect ratios from each other (i.e., the browser graphic storage unit 11 stores example browser graphics according to various aspect ratios). In case of an interactive DVD as an example, the browser browses predetermined interactive mode contents (i.e., interactive markup documents), and the browser graphic is the graphic included in the browser, for example, a submit button, a reset button, a checkbox, or a radio button realized by a form tag in an interactive contents markup document, which are contents allowing interactive functions with the user, for example, controlling control a digital video disk (DVD) image. In the present invention, the interactive contents are typically based on enhanced navigation (ENAV) suggested by an industry association, such as the DVD FORUM (http://www.dvdforum.org). When the browser is displayed on various display devices having different aspect ratios, for example, a personal computer (PC) monitor having a 1:1 aspect ratio, a television having a 4:3 aspect ratio, and a widescreen television having a 16:9 aspect ratio, the browser is converted into the aspect ratio of the corresponding display device using an anamorphic method used to reproduce the DVD image. A frame of the DVD image or information displayed by the browser is an image of low concentration, but the browser graphic is an image of high concentration in which a few to tens of pixels are concentrated, and thus, if the aspect ratio is changed, the shape of a pixel is also changed. Therefore, the text of the browser graphic may be distorted, and a high quality image cannot be displayed when the browser graphic is displayed on a different aspect ratio display device from the aspect ratio of the browser graphic. Furthermore, if the text of the browser graphic is largely distorted, it may not be readable. Thus, when a browser producer (i.e., browser manufacturer) produces the browser, the browser producer should produce various browser graphics of different aspect ratios and provide the graphics to a contents displayer (display device) according to the display device type. For example, the browser producer should produce a submit button with a 1:1 aspect ratio, a submit button with a 4:3 aspect ratio, and a submit button with a 16:9 aspect ratio, and provide the buttons to the contents displayer, if the contents displayer is a PC monitor, a television or a widescreen television, respectively. Typically, when the browser is installed in a reproducing device, the browser graphics with different aspect ratios are downloaded from the Internet or CD ROM and stored in a non-volatile memory in the reproducing device.

The initialization file storage unit 14 stores an initialization file including predetermined aspect ratio information, thereby providing an aspect ratio initialization file. The initialization file includes reproducing environment information of the interactive contents. Typically, the initialization file has a file extension.ini, and sets an initial environment so that an application or a system can be operated. In the present embodiment, the initialization file sets the reproduction environment of the interactive contents. For example, the initialization file can set required parameters before an ENAV page, which is displayed to the user, is displayed in the ENAV mode suggested by the DVD FORUM, and provides the browser with information regarding the entire or some interactive contents. The aspect ratio information can be obtained a variety of ways, as follows.

For example, according to an aspect of the invention, the contents producer (i.e., contents manufacturer, such as the DVD manufacturer in case of the interactive DVD example) may create the initialization file including the aspect ratio as a default. That is, for example, the contents producer creates the initialization file including the aspect ratio information, which is determined when the browser graphic is created, and the browser reads out the aspect ratio information from the initialization file to select the browser graphic corresponding to the read aspect ratio so that the browser graphic can be represented without distortion. Even if the aspect ratio of the browser is changed, the browser graphic with a constant aspect ratio can be displayed on the screen.

According to another aspect of the invention, the aspect ratio can be received from the user, by using the interactive contents. That is, the aspect ratio information receiver 12 receives the aspect ratio information from the user, the initialization file creator 13 creates the initialization file including the aspect ratio information received from the aspect ratio receiving unit 12, and the initialization file storage unit 14 stores the initialization file created in the initialization file creator 13. One of various display modes, such as standard mode (4:3 aspect ratio) and widescreen mode (16:9 aspect ratio) can be selected in the reproducing device (for example, in the widescreen television). Thus, the browser graphic is displayed according to a choice of the user.

According to another aspect of the invention, the aspect ratio can be received from the reproducing device using a plug-and-play method. That is, the aspect ratio receiving unit 12 receives the aspect ratio information from the reproducing device using the plug-and-play method, the initialization file creator 13 creates the initialization file including the aspect ratio received from the aspect ratio information receiver 12, and the initialization file storage unit 14 stores the initialization file created in the initialization file creator 13. Information regarding the display devices of the reproducing devices, such as the PC monitor, the television, and the wide television, on which the browser will be displayed is recognized automatically in the plug-and-play method, and the browser graphic is selected according to the display device.

According to another aspect of the invention, the initialization file can be implemented as a markup document coded in the markup language, such as HTML. In particular, the initialization file storage unit 14 can store the initialization markup document that includes the aspect ratio information using a meta tag. Further, according to this aspect of the invention, when a new tag for the aspect ratio is defined by the DVD FORUM, an initialization markup document including the newly defined tag can be stored. Also, according to another aspect of the invention, the initialization markup document can be stored with the aspect ratio in a form of newly defined attributes or script.

The aspect ratio information extractor 15 extracts the aspect ratio information from the initialization file stored in the initialization file storage unit 14. When the initialization file is the initialization markup document, the aspect ratio is extracted through a document object model (DOM) tree constructing process generally applied to markup documents.

The reproducing order receiver 16 receives an order to reproduce the interactive contents from the user. The aspect ratio information extractor 15 extracts the aspect ratio information from the stored initialization file before the interactive contents are reproduced. According to an aspect of the invention, the aspect ratio information should be extracted from the initialization file before the interactive contents are reproduced due to characteristics of the initialization file affecting reproduction.

The browser graphic selector 17 selects the browser graphic corresponding to the aspect ratio information extracted by the aspect ratio information extractor 15 from the browser graphics stored in the browser graphic storage unit 11. The browser graphic displaying unit 18 displays the browser graphic selected by the browser graphic selection unit 17. For example, when graphic data for the 1:1 submit button, 4:3 submit button and 16:9 submit button are stored in the browser graphic storage unit 11, and the aspect ratio information extracted by the aspect ratio information extractor 15 is 4:3, the browser graphic selector 17 selects the 4:3 submit button, and the browser graphic display unit 18 displays the 4:3 submit button.

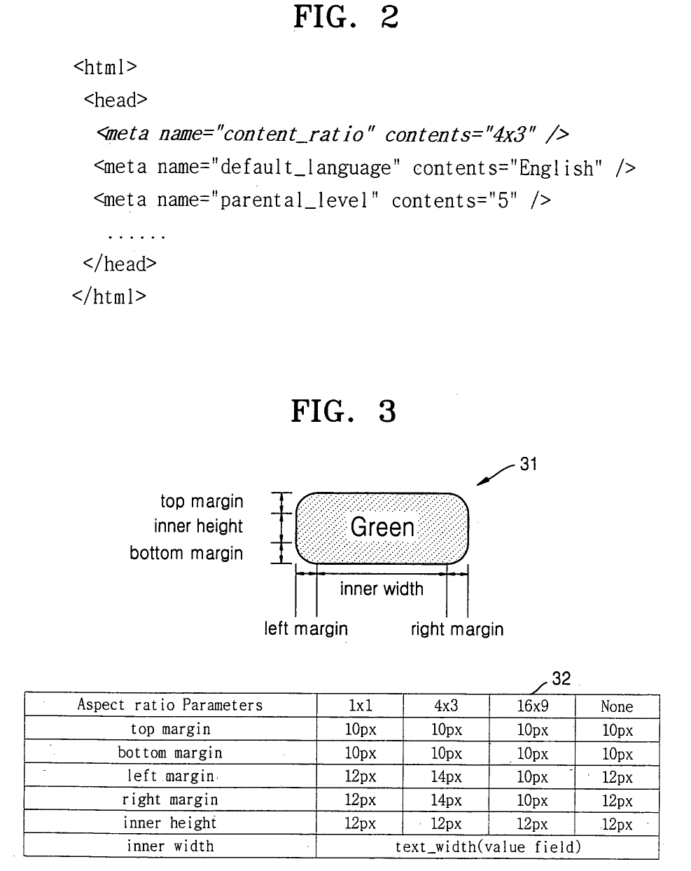

FIG. 2 is an example of a markup document source code, which is an example of the aspect ratio information initialization file implemented as the initialization markup document, according to an embodiment of the present invention. Referring to FIG. 2, the initialization markup document is coded in HTML, and includes the aspect ratio information in a meta tag. The section <meta name=“content_ratio” contents=“4:3”/> represents that (identifies) the aspect ratio of the contents is 4:3. The aspect ratio can be set as a default by the contents producer, or obtained from the user or the reproducing device. The section <meta name=“default_language” contents=“English”/> sets the default language to English. The section <meta name=“parental_level” contents=“5”/> sets the contents included to a parental level, that is, to level 5. The initialization file is run before the interactive contents are run, thus, the interactive contents, that is, for example, the DVD image and a help browser, will be provided with a 4:3 aspect ratio, in the English language, and at a viewing level of 5.

FIG. 3 illustrates an input button, which is an example of the browser graphics produced according to an aspect ratio, according to an embodiment of the present invention. As an example, a submit button and a reset button are represented by the input button 31, and set, for example, using an input tag in a form tag of the interactive contents markup document. For example, the submit button is set as<input type=“submit”>. The attribute of the input type, that is, whether the input button is “submit” or “reset,” is decided by the HTML document producer.

Table 32 of FIG. 3 includes information regarding shapes of the input button 31 according to various aspect ratios, in which the shapes should be provided by the browser producer/manufacturer via the browser graphic storage unit 11. The table 32 includes the numbers of pixels for a top margin, a bottom margin, a left margin, a right margin, an inner height, and an inner width of the button when a 1:1, 4:3, 16:9, or no aspect ratio is provided (i.e., graphic information of the input button that will be displayed when the aspect ratio information is not provided). The inner width is determined by the number of characters input by the user, and is set as a value field. One of the differing aspect ratio input buttons 31 is selected according to the default aspect ratio set by the contents producer, a request of the user or the reproducing device depending on the kind of display device.

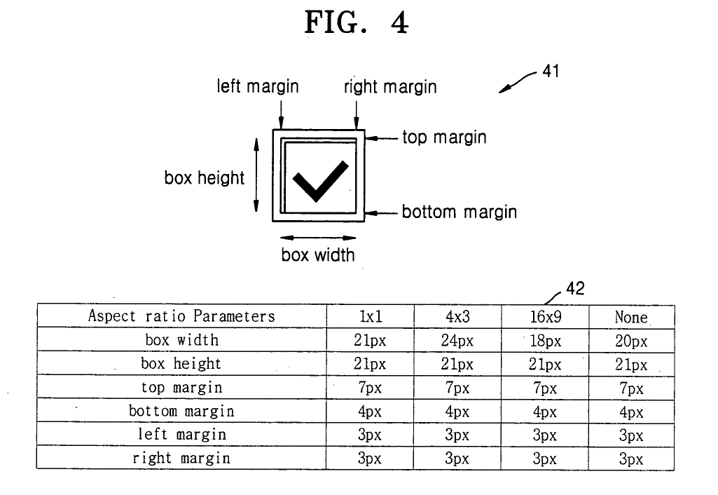

FIG. 4 illustrates a checkbox, which is an example of the browser graphics reproduced according to an aspect ratio, according to an embodiment of the present invention. For example, the checkbox 41 is set using an input tag in a form tag of the interactive contents markup document. For example, the checkbox 41 is set by the tag <input type=“checkbox”>, in which the attribute value of the input type is set by the HTML document producer.

In FIG. 4, table 42 includes information regarding shapes of the checkbox 41 according to various aspect ratios, in which the shapes should be provided by the browser producer/manufacturer via the browser graphic storage unit 11. The table 42 includes the numbers of pixels for a box width, box height, top margin, bottom margin, left margin, and right margin of the checkbox when a 1:1, 4:3, 16:9, or no aspect ratio is provided. One of the differing aspect ratio checkboxes 41 is selected and displayed according to the default aspect ratio set by the contents producer, the requirement of the user or the reproducing device depending upon the kind of display device.

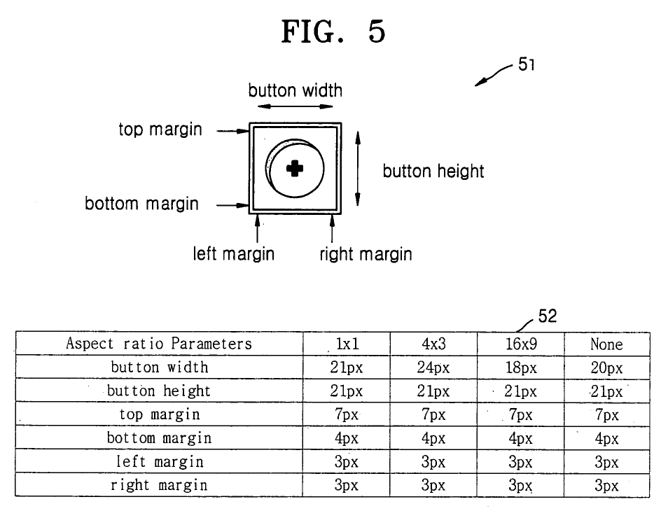

FIG. 5 illustrates a radio button, which is an example of the browser graphics produced according to an aspect ratio, according to an embodiment of the present invention. For example, the radio button 51 is set using an input tag in a form tag of the interactive contents markup document. For example, the radio button 51 is set by the tag <input type=“radio”>, in which the attribute value of the input type is set by the HTML document producer.

In FIG. 5, table 52 includes information regarding shapes of radio button 51 according to various aspect ratios, in which the shapes should be provided by the browser producer/manufacturer via the browser graphic storage unit 11. The table 52 includes the numbers of pixels for a button width, a button height, a top margin, a bottom margin, a left margin, and a right margin of the radio button when a 1:1, 4:3, 16:9, or no aspect ratio is provided. One of the differing aspect radio buttons 51 is selected according to the default aspect ratio set by contents producer, a request of the user or the reproducing device depending on the kind of display device.

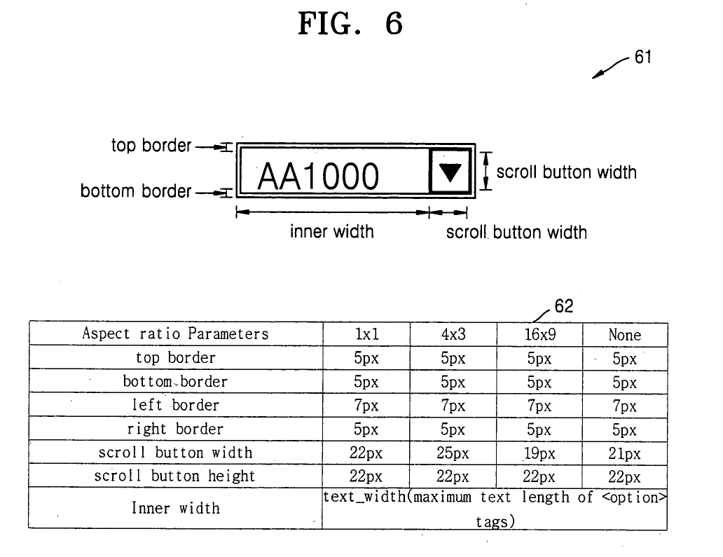

FIG. 6 illustrates a drop box, which is an example of the browser graphics produced according to an aspect ratio, according to an embodiment of the present invention. For example, the drop box 61 is set using a select tag in a form tag of the interactive contents markup document. For example, the drop box 61 is set by the tag <select name=“xxx”>, in which the attribute value of the select name is set by the HTML document producer. In addition, an attribute value of size (the number of items shown on the screen when the drop box is selected) is not set so that the drop box, in which only one selection item is displayed, can be set.

In FIG. 6, table 62 includes information regarding shapes of the drop box 61 according to various aspect ratios, in which the shapes should be provided by the browser producer/manufacturer via the browser graphic storage unit 11. The table 62 includes the number of pixels for a top border, a bottom border, a left border, a right border, a scroll button width, a scroll button height, and an inner width of the drop box 61 when a 1:1, 4:3, 16:9 or no aspect ratio is provided. For example, the inner width can be determined by the number of characters input by the user, and is set as a value field. In the FIG. 6 example, the number of characters of a selection with the most characters determines the inner width. One of the differing aspect ratio drop boxes 61 is selected according to the default aspect ratio set by the contents producer, a request of the user or the reproducing device depending on the kind of display device.

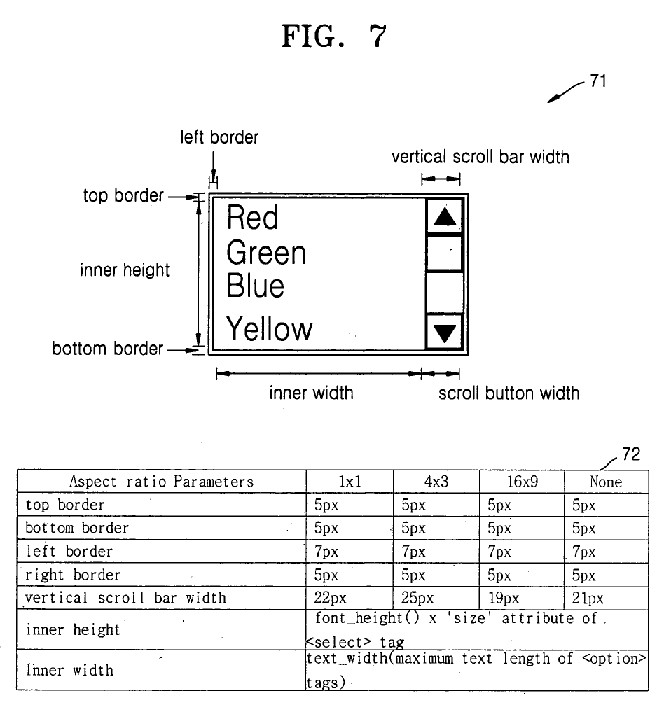

FIG. 7 illustrates a list box, which is an example of the browser graphics produced according to an aspect ratio, according to an embodiment of the present invention. For example, the list box 71 is set using a select tag in a form tag of the interactive contents markup document. For example, the list box 71 is set by the tag <select name=“color”>, in which the attribute value of the select name is set by the HTML document producer. In addition, an attribute value of size, which indicates the number of items shown on the screen, can be set to 2 or greater. In the list box 71 of FIG. 7, the attribute value of the size is set as 4.

In FIG. 7, table 72 includes information regarding shapes of the list box 71 according to various aspect ratios, in which the shapes should be provided by the browser producer/manufacturer in the browser graphic storage unit 11. The table 72 includes the number of pixels of a top border, a bottom border, a left border, a right border, a vertical scroll bar width, an inner height, and an inner width and height of the list box 71 when a 1:1, 4:3, 16:9 or no aspect ratio is provided. For example, the inner width can be determined by the number of characters input by the user, and is set as a value field. In the FIG. 7 example, the inner width is determined by the number of characters of a selection with the most characters. One of the differing aspect ratio list boxes 71 is selected according to the default aspect ratio set by the contents producer, a request of the user, or the reproducing device depending on the kind of display device.

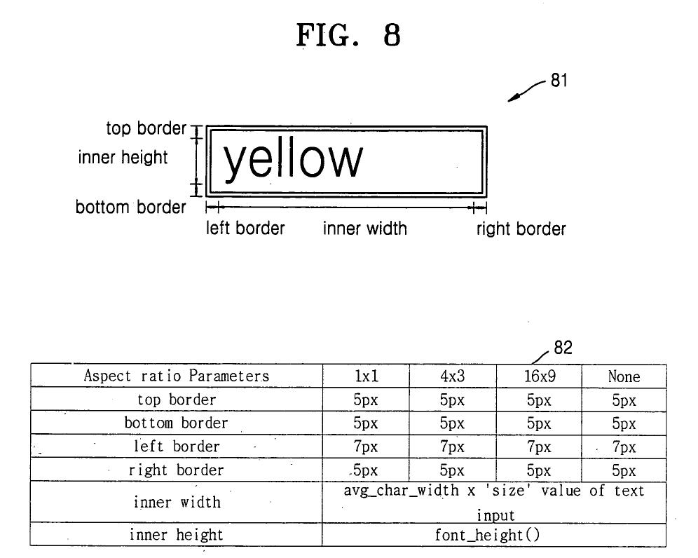

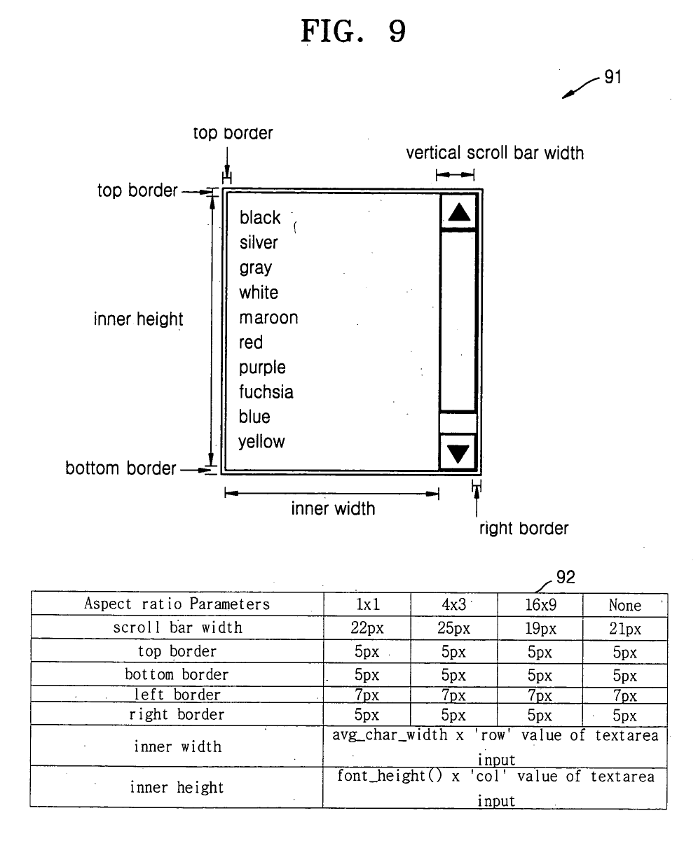

FIG. 8 illustrates a text window, which is an example of the browser graphics produced according to an aspect ratio, according to an embodiment of the present invention. For example, the text window 81 is set using an input tag in a form tag of the interactive contents markup document. For example, the text window 81 is set by the tag <input type=“text”>, in which the attribute value of the input type is set by the HTML document producer.

In FIG. 8, table 82 includes information regarding shapes of the text window 81 according to various aspect ratios, in which the shapes should be provided by the browser producer/manufacturer via the browser graphic storage unit 11. The table 82 includes the numbers of pixels of a top border, a bottom border, a left border, a right border, an inner height, and an inner width and height of the text windows when a 1:1, 4:3, 16:9, or no aspect ratio is provided. The inner width is determined by the number of characters input by the user, and is set as a value field. Also, the inner height can be decided by the height of a font of the characters. One of the differing aspect text windows 81 is selected according to the default aspect ratio set by the contents producer, a request of the user, or the reproducing device depending on the kind of display device.

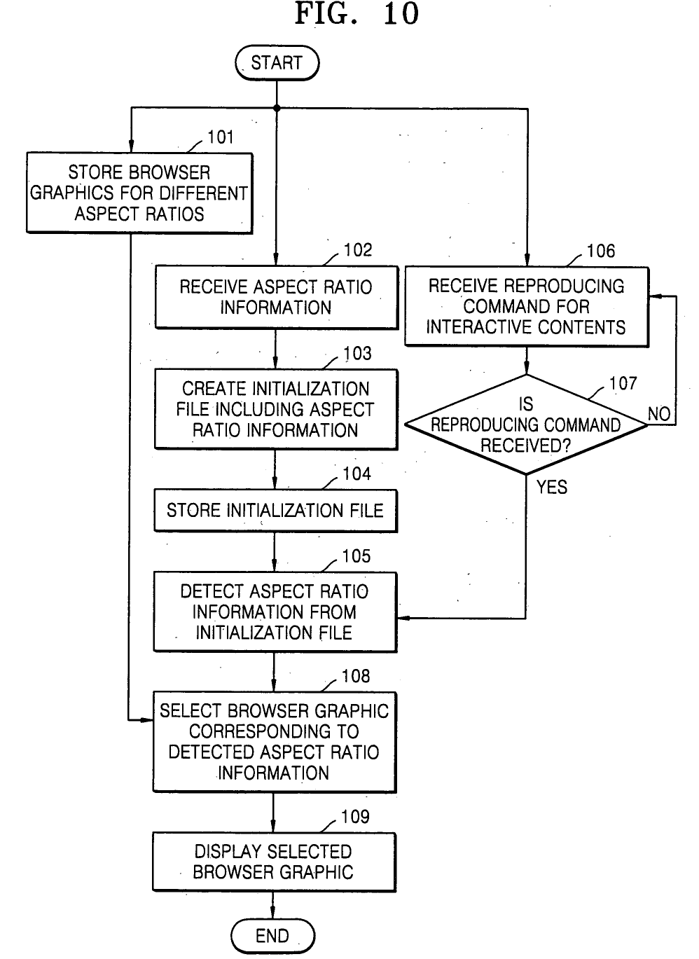

FIG. 9 illustrates a text area window, which is an example of the browser graphics produced according to an aspect ratio, according to an embodiment of the present invention. For example, text area window 91 is set using a textarea tag in a form tag of the interactive contents markup document. For example, the text area window 91 can be set by the tag <textarea rows=“8” cols=“40” name=“text”>, in which the attribute values are set by the HTML document producer.

In FIG. 9, table 92 includes information regarding shapes of the text area window 91 according to various aspect ratios, in which the shapes should be provided by the browser producer/manufacturer via the browser graphics storage unit 11. The table 92 includes the numbers of pixels of a scroll bar width, a top border, a bottom border, a left border, a right border, an inner height, and an inner width and height of the text window 91 when a 1:1, 4:3, 16:9, or no aspect ratio is provided. For example, the inner width can be determined by the number of characters input by the user, and is set as a value field. Also, since the inner height can be decided by the column value of the text area input by the user, the inner height is also set as a value field.

FIG. 10 is a flow chart of displaying browser graphics, according to an exemplary embodiment of the present invention. At operation 101, the browser graphics, which are included in browsers and to be displayed with different aspect ratios, are stored. Here, as an example, the browser browses predetermined interactive contents of an interactive DVD. In addition, at operation 104, the aspect ratio initialization file including the default aspect ratio information set by the contents producer as a default is stored. At operation 102, the aspect ratio information may be received from a user or from a plug-and-play display device of a reproducing device which will display the interactive contents. At operation 103, the initialization file is created, which includes the received aspect ratio information or a default aspect ratio set by a contents producer, and at operation 104, the initialization file is stored.

Typically, the initialization file also includes the information regarding a reproducing environment for the interactive contents markup documents as the interactive contents. If the initialization file is a markup document file, then the initialization file includes the aspect ratio information in a meta tag form, a newly defined tag form, a newly defined attribute form, or a script form (as the case may be). At operations 106-107, it is determined whether a command for reproducing the interactive contents is received, for example, from the user. At operation 105 the aspect ratio information is detected (extracted) from the stored initialization file before the interactive contents are reproduced, when, in operation 107, the command for reproducing the contents is received. At operation 108, a browser graphic corresponding to the extracted aspect ratio information is selected from the stored browser graphics. At operation 109, the selected browser graphic is then displayed.

According to the exemplary embodiments of the present invention, browser graphics with various aspect ratios are provided so that the browser graphics are prevented from being distorted when displayed on various display devices, and to display a browser graphic corresponding to a default set by a contents producer, a request of a user, or the characteristics of a display device. If the exemplary embodiments of the present invention are applied to a browser for an interactive DVD, which is displayed on display devices having various aspect ratios, a high-quality image can be displayed without distortion regardless of the kind of display device. The above-described processes of the present invention are typically implemented in software controlling a markup document reproducing device, such as a computer, a DVD player playing interactive DVDs, etc. The browser graphic storage unit 11 may be implemented according to any technique to provide a browser accessible (or selectable) browser graphics according to a plurality of aspect ratios, such as by providing browser graphic files stored in a data storage of the reproducing device, providing browser graphic files stored in a data storage storing the interactive contents markup documents to be produced (e.g., on an interactive DVD), providing browser graphics via a network server, automatically generating browser graphics, etc. The present invention provides a method comprising shapely (i.e., without distortion, proportional according to application criteria, having a regular or eye pleasing shape) displaying a browser graphic of a browser by selecting a display aspect ratio of the browser graphic according to a display device type displaying the browser graphic. Therefore, the present invention also provides an interactive DVD comprising multimedia data, such as audio/video data; interactive contents markup documents related to the multimedia data; and browser graphic aspect ratio information to control browser graphics of a browser browsing the interactive contents to reproduce the interactive contents.

The above described exemplary embodiments of the present invention can be realized by a computer-readable program stored on a computer-readable recording medium. The computer-readable recording medium includes a magnetic storing medium (for example, a ROM, a floppy disk, a hard disk, etc.), an optical reader (for example, a CD-ROM, a DVD, etc.), and a carrier wave (for example, data transmission through Internet).

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. An apparatus that displays browser graphics, comprising:
a browser graphic storage unit, which stores browser graphics of different aspect ratios according to the aspect ratios;
an initialization file storage unit, which stores an initialization file including predetermined aspect ratio information;
an aspect ratio information extractor, which extracts the aspect ratio information from the initialization file stored in the initialization file storage unit;
a browser graphic selector, which selects the browser graphic, which corresponds to the aspect ratio extracted by the aspect ratio information extractor, from the browser graphics of different aspect ratios stored in the browser graphic storage unit; and
a browser graphic display unit, which displays the browser graphic selected by the browser graphic selector.

2. The apparatus of claim 1, further comprising a browser unit browsing predetermined interactive contents markup documents as interactive contents to reproduce the interactive contents, and wherein the initialization file includes information regarding a reproduction environment of the interactive contents.

3. The apparatus of claim 2, further comprising a reproducing command receiver that receives a command for reproducing the interactive contents from a user,
wherein when the reproducing command is received by the reproducing command receiver, the aspect ratio information extractor extracts the aspect ratio information from the stored initialization file before the interactive contents are reproduced.

4. The apparatus of claim 2, wherein the initialization file is a markup document.

5. The apparatus of claim 4, wherein the markup document includes the aspect ratio information in one of a meta tag form, a newly defined tag form, a newly defined attribute form, or a script form, according to a markup language.

6. The apparatus of claim 2, wherein the initialization file includes a default aspect ratio, which is set by a producer of the interactive contents.

7. The apparatus of claim 1, further comprising:
an aspect ratio information receiver, which receives the aspect ratio information from a user; and
an initialization file creator, which creates the initialization file including the aspect ratio information received by the aspect ratio information receiver,
wherein the initialization file storage unit stores the initialization file created by the initialization file creator.

8. The apparatus of claim 2, further comprising:
an aspect ratio information receiver, which receives the aspect ratio information by a plug-and-play method from a display device which will display the interactive contents; and
an initialization file creator, which creates the initialization file including the aspect ratio information received by the aspect ratio information receiver,
wherein the initialization file storage unit stores the initialization file created by the initialization file creator.

9. A method of displaying browser graphics comprising:
storing browser graphics with different aspect ratios according to the aspect ratios;
storing an initialization file including predetermined aspect ratio information;
extracting the aspect ratio information from the initialization file;
selecting a browser graphic corresponding to the extracted aspect ratio; and
displaying the selected browser graphic.

10. The method of claim 9, further comprising:
browsing predetermined interactive contents markup documents as interactive contents to reproduce the interactive contents; and
storing in the initialization file information regarding a reproduction environment of the interactive contents.

11. The method of claim 10, further comprising:
receiving a command for reproducing the interactive contents from a user,
wherein when the reproducing command is received, the extracting of the aspect ratio information occurs before the interactive contents are reproduced.

12. The method of claim 10, wherein the initialization file is a markup document.

13. The method of claim 12, wherein the markup document includes the aspect ratio information in one of a meta tag form, a newly defined tag form, a newly defined attribute form, or a script form, according to a markup language.

14. The method of claim 10, wherein the initialization file includes default aspect ratio information set by an interactive contents producer.

15. The method of claim 9, further comprising:
receiving the aspect ratio information from a user;
creating the initialization file including the received aspect ratio information; and
storing the created initialization file.

16. The method of claim 10, further comprising:
receiving the aspect ratio information by a plug-and-play method from a display device which will display the interactive contents;
creating the initialization file including the received aspect ratio information; and
storing the created initialization file.

17. A computer-readable recording medium having a program for performing a method of displaying browser graphics by aspect ratios in a computer, the method comprising:
storing browser graphics with different aspect ratios according to their aspect ratios;
storing an initialization file including predetermined aspect ratio information;
extracting the aspect ratio information from the initialization file;
selecting a browser graphic corresponding to the extracted aspect ratio; and
displaying the selected browser graphic.

18. A method, comprising:
shapely displaying a browser graphic of a browser by selecting a display aspect ratio of the browser graphic according to a display device type displaying the browser graphic.

19. An interactive digital video disc controlling a reproduction device, the disc comprising:
multimedia data;
interactive contents markup documents related to the multimedia data; and
browser graphic aspect ratio information to control browser graphics of a browser browsing the interactive contents to reproduce the interactive contents.
